(19) United States
(12) Patent Application Publication
(10) Pub. No.: US 2003/0220213 A1
(43) Pub. Date: Nov. 27, 2003

(54) Color changing floor finish stripper

(76) Inventor: Andrew M. Bober, Racine, WI (US)

Correspondence Address: S.C. JOHNSON COMMERCIAL MARKETS INC, 8310 16TH STREET, M/S 510, PO BOX 902, STURTEVANT, WI, 53177-0902, US

(21) Appl. No.: 10/155,283

(22) Filed: May 24, 2002

(51) Int. Cl. C11D 1/00

(52) U.S. Cl. 510/214

(57) ABSTRACT

A floor finish remover composition which includes a floor finish remover formulation and a color indicator incorporated into the formulation. The color indicator is capable of indicating a color change in conjunction with the floor finish to provide a visual cue as to the conditions of the stripper and the floor. Preferably, the floor finish is acidic and the floor finish remover is alkaline. The color indicator is pH sensitive and changes color in a pH range of 8-12.

### CROSS-REFERENCE TO RELATED APPLICATIONS

None

### STATEMENT REGARDING FEDERALLY SPONSORED RESEARCH OR DEVELOPMENT

None

### BACKGROUND OF THE INVENTION

1. Technical Field

This invention relates generally to floor finish stripping materials. More particularly it relates to a floor finish stripping material with a color indicator to provide the user with a visual cue as to the condition of the stripper and the floor.

2. Background Art

The use of color indicators in floor coating and polishing products to indicate the presence or depletion of the product is well known. U.S. Pat. Nos. 4,070,510 and 4,071,645, disclose aqueous floor coating and polish compositions containing an indicator which is colored at a pH above a predetermined level and is colorless at a lower pH. The compositions are colorless upon drying, but when contacted with a stripping solution with a pH above a certain level causes the film to revert to its original color so that one can readily observe whether the old film has been completely removed. Several color indicators are disclosed including phenolphthalein, thymolphthalein and o-cresolphthalein.

U.S. Pat. No. 4,248,597 proposes a depletion indicator for removable substances containing an acidic or basic component in a pet collar. The device consists of a permeable film, and a porous matrix, containing both a predetermined amount of an acid or base containing a removable substance and a pH color indicator. The pH indicator again may be phenolphthalein, o-cresolphthalein or alizarin yellow. When the removable substance contacts the pH indicator, a color change occurs as the concentration of the removable substance diminishes by passing through the permeable film of the depletion indicator. Furthermore, the color change occurs at a predetermined time, i.e.; the time at which the active ingredient has diminished to ineffectual levels.

U.S. Pat. No. 3,926,830 discloses a detergent formulated with a pH indicative polymer which is used to alert consumers to any decrease in the activity of the detergent. Preferable, a phthalein or azo indicator is condensed or addition polymerized onto any appropriate polymer or monomer.

U.S. Pat. No. 4,971,631 teaches a hard surface cleaner that may include optional pH indicators, such as phenolphtalein or thymolphthalein. The pH indicator is intended to disclose the depletion of acidity to the user.

U.S. Pat. No. 3,669,891 discloses cleansing compositions, such as surface cleaners and polishes which emit visible light during use. The commencement or termination of luminescence may be used to indicate satisfactory dispersal of the composition, or that sufficient time has elapsed for said composition to perform its intended function.

What is not shown in the prior art is the utilization of the color indicator in a floor finish stripper. When a stripping solution is applied to a floor, the general guidelines are to let the solution sit on the finish for 10 minutes before scrubbing. In practice, however, workers often start scrubbing immediately after wetting the floor, which does not give sufficient time for the stripper to dissolve the finish. Likewise, in cases where there is heavy buildup of old finish, the stripping solution is chemically spent before it can dissolve all of the finish, but it is impossible to tell when this has occurred. By adding an indicator to the stripping solution, workers have a visual cue as to how long to wait until scrubbing, if the stripping solution has been consumed by the finish, or if the stripping solution has penetrated all the way to the floor. These indicators also have a secondary effect in that some of the indicator dye remains on the floor or tile (even after damp-mop rinsing), so that they can also act as penetration indicators on subsequent strip-outs, even if a non-color indicating stripper is used.

The objects of the invention therefore are:

Providing an improved floor finish stripper.

Providing a floor finish stripper having an indication of the time to initiate removal of the finish.

Providing a floor finish stripper having an indication of its consumption by the finish.

Providing a floor finish stripper having an indication of its penetration into the finish.

Providing a floor finish stripper of the foregoing kind which is readily adaptable to a commercially available floor finish stripper.

### SUMMARY OF THE INVENTION

The foregoing objects are accomplished and the shortcomings of the prior art are overcome by the floor finish remover composition of this invention which includes a floor finish remover formulation and a color indicator incorporated in the formulation. The color indicator is capable of indicating a color change in conjunction with the floor finish.

In one embodiment the floor finish is acidic.

In another embodiment the floor finish remover is alkaline.

In still another embodiment the floor finish remover contains benzyl alcohol.

In yet another embodiment the floor finish remover contains a source of alkalinity and solvents to effect penetration and swelling of films.

In one aspect the color indicator is pH sensitive.

In another aspect the color indicator changes color in a pH range of 8-12.

### DESCRIPTION OF PREFERRED EMBODIMENTS

In the following Examples certain stripper and floor finish products are referred to. The stripper products are Freedom, Freedom S.C., Prostrip and Bravo which are alkaline. The floor finish products are Vectra and Carefree. These are all available from JohnsonDiversey, Inc., Sturtevant, Wisc. Freedom S.C. is covered in U.S. Pat. No. 5,977,042 and contains benzyl alcohol. The basic active ingredients in Freedom, Prostrip and Bravo are as follows:

Freedom: monoethanolamine, sodium silicate solution and sodium hydroxide as sources of alkalinity; ethylene glycol phenyl ether and propylene glycol n-butyl ether as solvents.

Pro-Strip: monoethanolamine, benzyl alcohol and ethylene glycol monobutyl ether.

Bravo: Sodium hydroxide and monoethanolamine.

These three formulas also contain surfactants for wetting and to solubilize the solvents in water.

Vectra is covered in U.S. Pat. No. 5,977,228 and is acidic as is Carefree.

### EXAMPLE 1

The purpose of this Example is to test the pH of stripping solutions as they penetrate multiple layers of floor finish. The product tested in this experiment is Freedom SC which contains benzyl alcohol.

Procedure:

20 coats of Vectra Floor finish were applied to a white vinyl composite tile and allowed to thoroughly dry overnight. A solution of Freedom SC was made from 1 part Freedom SC to 15 parts water. One milliliter of stripper was placed on the coated tile and pH paper was used to follow the course of pH change in the stripping solution.

Results:

pH (bulk initial soln)=10.8 as measured on pH meter.

pH (10 min on film)=10.0 as measured on pH paper.

### EXAMPLE 2

The purpose of this Example is to add an indicator dye to Freedom SC to see if a color change can be observed in use.

Procedure:

A solution of Freedom SC was made from 1 part Freedom SC to 15 parts water. To this solution was added 0.25 ml of Universal Indicator which forms a purple solution.

Results:

When applied to 20 coats of Vectra floor finish, the color slowly changes from purple to green (neutral pH). Upon rinsing of the now green stripper solution, the finish beneath the solution was not completely removed.

In a subsequent test, the stripper solution was re-applied as the solution on the tile turned green until the applied solution no longer changed color. This solution, when rinsed, left a bare tile.

### EXAMPLE 3

The purpose of this Example is to test another stripper Prostrip as per Example 2 with the key ingredients as previously indicated.

Results:

Begins deeply colored blue/green in concentrate and purple upon dilution. Overnight, concentrate turns green which does not change to purple when dilute. No further color change upon application to tile was observed.

The results indicate that the color indicator and the stripper are not operative.

### EXAMPLE 4

This Example illustrates the use of a color indicator with Freedom stripper with the key ingredients as previously indicated.

Procedure:

Forms a dark blue/green concentrate, purple when dilute.

Results:

Results were an incomplete removal of finish. Additional stripping solution was added as long as the color continued to change from purple to green. During this time, the finish was still neutralizing the stripper. When all the finish was reacted, the color of the stripping solution remained purple.

### EXAMPLE 5

The purpose of this Example is to add a pH indicator dye to Freedom for stability testing. Samples were kept at room temperature, 40 ° C. and 50° C. and observed for color loss.

WT %

| Ingredient | Run 1 | Run 2 | Run 3 |
|---|---|---|---|
| Freedom | 99.99 | 99.99 | 99.99 |
| o-Cresolphthalein | 0.01 | — | — |
| Thymolphthalein | — | 0.01 | — |
| Phenolphthalein | — | — | 0.01 |
| | 100.00 | 100.00 | 100.00 |

Run 1 - forms a deep purple solution
Run 2 - forms a dark blue solution
Run 3 - forms a deep pink/red solution

Results:

Run 1 (o-cresolphthalein) also loses color over time at 50° C. although it has retained some of its color at room temp. However, even at RT it is considerably lighter than the original, so there has been some color loss.

Run 2 (thymolphthalein) retained its color at both 50° C. and room temperature.

Run 3 (phenolphthalein) rapidly loses color at 50° C., and more slowly at room temperature, but over the course of several weeks the color fades to a pale yellow.

At 4° C., all samples retained their color. The Run 3 samples did show some fading, but they were still very pink.

### EXAMPLE 6

The purpose of this Example is to add pH indicators to Prostrip for stability testing. Samples are evaluated for color stability at 4° C., room temperature and, 50° C.

WT %

| Ingredient | Run 1 | Run 2 | Run 3 |
|---|---|---|---|
| Prostrip | 99.99 | 99.99 | 99.99 |
| o-Cresolphthalein | 0.01 | — | — |
| Thymolphthalein | — | 0.01 | — |
| Phenolphthalein | — | — | 0.01 |
| | 100.00 | 100.00 | 100.00 |

Run 1 - forms a deep purple solution
Run 2 - forms a dark blue solution
Run 3 - forms a deep pink/red solution

Results:

Run 1 (o-cresolphthalein) fades at both room temp and 50° C., but both retain a purple color.

Run 2 (thymolphthalein) shows no obvious color loss at either temperature.

Run 3 (phenolphthalein) rapidly loses color at 50° C. to form a yellow solution. At room temp, the intensity of the color decreases, but the solution remains pink.

At 4° C., all samples retained their color. The Run 3 samples did show some fading, but they were still very pink.

### EXAMPLE 7

The purpose of this Example is to test the concept of a color-indicating stripper similar to those described in the previous example but using the conventional, highly alkaline Bravo instead of the amine solvent based Freedom or Prostrip.

Ingredient

| | |
|---|---|
| Bravo | 99.95% |
| Thymolphtalein | 0.05% |

When the colored Bravo is applied to multiple coats of floor finish (in this case 20 coats of Vectra on half a 12″×12″ tile, and 5 coats on the other half were used), the stripping solution changed from blue to colorless where the stripper did not penetrate and dissolve all the layers of finish, but remained blue on those areas where the stripper did penetrate and dissolve all layers of the finish. On those areas that changed to colorless, when additional colored stripper was applied, this colored-to-colorless change went on with each subsequent application of stripper until all layers of finish were penetrated and dissolved. In this test it took a total of three applications of stripper for the color to remain blue.

### EXAMPLE 8

This Example illustrates the testing of a stripper with a color indicator as applied to a floor finish.

A section of a hallway with Carefree-coated terrazzo was used as the substrate. Two stripper buckets were filled with approximately four gallons of water. Freedom stripper was added to each bucket directly from a five gallon plastic container. At or about the proper 1:4 dilution, in the lab Freedom becomes cloudy. In reality, however, by adding the stripper directly from the large plastic container, the splashing of the stripper causes so much foam to develop on the solution's surface that it becomes completely obscured, thus rendering any visual clues to proper dilution rate somewhat ineffective.

A solution of 1 gram thymolphthalein in isopropanol was added to one of the buckets of diluted Freedom to form a dark blue solution. This was identified as the Morgan test solution. The isopropanol was used as a diluent for the thymolphthalein because working with small quantities of powders is difficult, especially in the field. It is easier to pre-dissolve small amounts of powders in a suitable solvent just so you have a reasonable volume of material to handle, plus, there are fewer concerns about proper mixing and complete dissolving if the powders are pre-dissolved. The 1 gram of thymolphthalein used is equivalent to having 0.026% thymolphthalein in the product prior to dilution..

One section of the floor was stripped with the uncolored Freedom according to label directions. The floor was completely wetted with the stripper, allowed to stand for 10 minutes, re-wetted with stripper, allowed to sit an additional 5 minutes, and then scrubbed with three passes of an autoscrubber fitted with black stripping pads. On the third pass, the solution was vacuumed off the floor and the floor was then damp-mopped to remove any stripper residues. This treatment did not strip the floor to bare terrazzo.

On the second section, the Morgan stripper was mop-applied to the floor. The solution quickly changed from blue to colorless, often in the time it took to coat a square meter area with stripper. Re-application caused a very brief return of color then just as quickly, the color disappeared. After the blue color was gone, the floor was scrubbed in the same manner as the first section, with similar results.

For the third section of floor, the stripping solution was applied by flooding the area with stripper by allowing it to drip from the mop, rather than spreading it This put down a much heavier application of stripper, and the color did not change for about 1 minute. After the color disappeared, the floor was scrubbed and rinsed.

Total stripper contact time for all three sections was 15-20 minutes. None of the floor sections were completely stripped. All of them looked roughly the same when the process was completed, although the absolute amount of finish left behind was not determined. The remaining finish was of sufficient quality and uniformity to allow re-coating without the need to strip to bear floor.

Conclusions:

Any visual dilution indicator would have to be used in conjunction with a non-foaming stripper or the visual cue would be obscured by foam in the mop bucket.

In principle, the Morgan stripper worked as planned. Because the color faded after every application, the inference was that the alkalinity of the stripper had been consumed and that the finish was not completely removed. This was indeed the case. What remains to be determined is what volume of stripper would have to be reapplied in order to strip the floor completely. As a corollary, would one be willing to use or reapply that much stripper in order to completely remove all the finish when an adequate re-coating can be accomplished with old finish in place?

For heavy finish build up, it appears that the length of time the stripper remains in contact with the finish is less important than normally thought. Given the speed at which the color of the Morgan product changed to colorless, the alkalinity of mop-applied stripper is quickly consumed, so any additional effect is derived solely from the solvents in the formulation. Even after 15 minutes of soaking and agitation, these floors were not completely stripped.

In order to apply enough of the Morgan stripper to the floor, it may be necessary to use a stripper applicator to drop spread the stripper.

The preferred pH range of a color indicator for use in this invention with a floor finish stripper is 8-11.5 with 8-10 being preferred. The color indicators which are operable within these ranges are: Cresol Red, Curcumin, m-Cresol Puple, 4,4′-Bis(4-amino-1-naphthylazo)-2,2′-stilbenedisulfonicAcid, Thymol Blue, o-Cresolphthalein, p-Naphtholbenzein, Phenolphthalein, Ethyl Bis(2,4-dinitrophenyl)acetate, Thymolphalein, Nile Blue A, 5-(p-Nitrophenylazo)salicylic Acid Sodium Salt. The preferred colored indicators are o-cresolphthalein, thymolphthalein, and phenolphthalien, in that order. The change from colored to colorless is most readily apparent, especially on non-white tile. Also, upon re-application of finish, any residual indicator left on the floor (from less than perfect rinsing or whatever) will not change the color of the floor or finish.

Certain stripper formulations and color indicator materials are specified herein. Any stripper formulation and color indicator can be used provided these materials are compatible and provide a color change in conjunction with a floor finish.

1. A floor finish remover composition comprising:
a floor finish remover formulation; and
a color indicator incorporated into the formulation, the color indicator capable of indicating a color change in conjunction with the floor finish.

2. The floor finish remover composition as defined in claim 1 wherein the floor finish is acidic.

3. The floor finish remover composition as defined in claim 1 wherein the floor finish remover is alkaline.

4. The floor finish remover composition as defined in claim 1 wherein the color indicator is pH sensitive.

5. The floor finish remover composition as defined in claim 4 wherein the color indicator changes color in a pH range of 8-12.

6. The floor finish remover composition as defined in claim 1 wherein the color indicator is o-cresolphthalein.

7. The floor finish remover composition as defined in claim 1 where in the color indicator is thymolphthalein.

8. The floor finish remover composition as defined in claim 1 wherein the color indicator is phenolphthalein.

9. The floor finish remover composition as defined in claim 1 wherein the floor finish remover contains benzyl alcohol.

10. The floor finish remover composition as defined in claim 1 wherein the floor finish remover contains monoethanolamine, sodium silicate solution and sodium hydroxide.

11. The floor finish remover composition is defined in claim 1 wherein the floor finish remover contains monoethanolamine, benzyl alcohol and ethylene glycol monobutyl ether.

12. The floor finish remover composition as defined in claim 1 wherein the floor finish remover contains sodium hydroxide and monoethanolamine.

13. A method of removing a floor finish employing the composition of claim 1.
